(19) United States
(12) Patent Application Publication
(10) Pub. No.: US 2023/0058555 A1
(43) Pub. Date: Feb. 23, 2023

(54) HYBRID MODULE WITH AN AXIALLY PARALLEL E-MACHINE AND VEHICLE COMPRISING SAME

(71) Applicant: ZF Friedrichshafen AG, Friedrichshafen (DE)

(72) Inventors: Alessio PAONE, Werneck (DE); Alexander BARTHA, Würzburg (DE); György MÜLLER, Bataszek (DE); Monika RÖSSNER, Donnersdorf (DE); Sebastian NEUGEBAUER, Gera (DE); Steffen MATSCHAS, Bad Bocklet (DE)

(21) Appl. No.: 17/797,315

(22) PCT Filed: Feb. 2, 2021
(86) PCT No.: PCT/EP2021/052363

§ 371 Date: Aug. 3, 2022

(30) Foreign Application Priority Data
Feb. 4, 2020 (DE) 10 2020 201 336.5

(51) Int. Cl. B60K 6/387; B60K 6/48; B60K 6/405

(52) U.S. Cl. CPC B60K 6/387; B60K 6/48; B60K 6/405; B60K 2006/4825; B60K 2006/4833; B60K 2006/268

(57) ABSTRACT

A hybrid module for arranging between an internal combustion engine, an electric machine and a transmission, wherein the hybrid module has an input shaft which is connectible to a torsional damper mounted at the internal combustion engine, wherein a starting element is provided, wherein a transmission shaft is connectible to the output side of the starting element, wherein the electric machine is arranged axially parallel to the input shaft, and wherein the electric machine is connected to the starting element by a traction mechanism drive, characterized in that a bearing plate is provided which is arranged directly adjacent the torsional damper, in that a disconnect clutch is provided between the input shaft and the starting element, and in that the disconnect clutch is constructed as dog clutch. The invention is further directed to a motor vehicle having such a hybrid module.

### PRIORITY CLAIM

This is a U.S. national stage of application No. PCT/EP2021/052363. Priority is claimed on German, Application No.: 10 2020 201 336.5; the content of which is incorporated herein by reference.

### BACKGROUND OF THE INVENTION

The invention is directed to a hybrid module for a hybrid drive of a vehicle in which a conventional drive is combined with an electric machine.

Hybrid drives are known in the art. Hybrid drives with an electric machine arranged coaxial to the driveshaft are common. Prior art in which the arrangement is carried out axially parallel is also known. Examples of this include DE 10 2017 110 606 A1 or DE 10 2010 003 442 A1.

### SUMMARY OF THE INVENTION

The invention has the object of providing a hybrid module having a small axial installation space in order, for example, to be applicable to existing vehicle concepts in a simple manner and having a lubrication concept in keeping with requirements. A further object is to improve reliability and applicability.

The above-stated object is met by a hybrid module for arranging between an internal combustion engine, an electric machine and a transmission. The hybrid module has an input shaft which is connected to a torsional damper mounted at the internal combustion engine. An output shaft extending coaxial to the input shaft is provided and is connected to the transmission. The output shaft is connected to the output side of a starting element. The electric machine is arranged axially parallel to the input shaft and output shaft. The electric machine is connected to the starting element by a traction mechanism drive. The invention is characterized in that the hybrid module is divided into at least three separate oil spaces, in that at least one of the oil spaces is formed as a dry space, in that the torsional damper is provided in the dry space, in that a bearing plate is provided which is arranged directly adjacent the torsional damper, in that at least two of the oil spaces are formed as wet spaces and are separated from one another, and in that a housing of the starting element forms one of the wet spaces.

The hybrid module is arranged in the powertrain between an internal combustion engine and a transmission and further has a connection to an electric machine. According to the invention, the electric machine is arranged axially parallel to the coaxially arranged input shaft and output shaft or transmission shaft, respectively. Installation space is saved in axial direction by means of the axially parallel arrangement.

A torsional damper is connected to the internal combustion engine and is likewise connectible, for example, via a spline, to the input shaft so as to be fixed with respect to rotation relative to it.

A starting element is provided between the input shaft and output shaft or transmission shaft in order to allow torque to be transmitted between the drive and the transmission also at different speeds.

The axially parallel electric machine is connected to the starting element via a traction mechanism drive. The traction mechanism drive is preferably formed as a chain drive with corresponding sprockets at the electric machine and starting element.

The hybrid module is divided into at least three separate oil spaces in order to allow for different lubricating conditions and cooling conditions. In this respect, at least one of the oil spaces is formed as a dry space. Components that require little or no lubrication are arranged in the dry space such as the torsional damper which is generally lubricated via its own grease space.

A bearing plate is provided for separating the dry space. This bearing plate is arranged next to the torsional damper in axial direction on the output side. In this respect, the bearing plate takes on additional tasks, which economizes on component parts.

At least two of the further oil spaces are constructed as wet spaces and separated from one another. The wet spaces may differ in particular with regard to the lubricants or coolants and/or fill level. One of the wet spaces is formed by a housing of the starting element. The starting element is preferably completely filled with an oil.

Preferred embodiment forms of a hybrid module are characterized in that the housing of the starting element is formed on the drive side as a closed wet space.

A further wet space is preferably formed in the area of the traction mechanism drive which preferably lubricates via an oil mist, immersion lubrication and/or a selective oil supply. The further wet space is bounded, for example, by the bearing plate and a housing of the hybrid module or a transmission cover, respectively.

Embodiment forms of a hybrid module are characterized in that the wet space in the housing of the starting element is connected to an oil circuit of the transmission. Owing to the spatial proximity, the oil supply of the starting element is advantageously carried out via the oil circuit of the transmission, particularly since the output shaft of the starting element is linked to the transmission, or a transmission shaft extends right into the starting element.

Hybrid modules according to embodiment forms are characterized in that the traction mechanism drive is linked to the housing of the starting element. A space-saving connection of the traction mechanism drive may be achieved in that, for example, the sprocket is mounted directly at the housing of the starting element. Depending on the shape of the housing, the traction mechanism drive can also overlap the housing in axial direction.

Embodiment forms of a hybrid module are characterized in that the traction mechanism drive is connected to the output side or to the input side of the starting element. Depending on the construction of the starting element, its use and function, respectively, the traction mechanism drive can be connected to the input side or output side. For example, if the starting element generally serves to improve the flow of power along the powertrain, a connection to the input side is advantageous. On the other hand, if the starting element can also be utilized to disconnect the internal combustion engine from the rest of the powertrain, it is advantageous to connect the traction mechanism drive and, therefore, the electric machine to the output side, since a separate disconnect clutch for all-electric driving can be dispensed with.

Hybrid modules according to embodiment forms are characterized in that a disconnect clutch is provided between the torsional damper and the starting element. A disconnect clutch can be provided in order to disconnect the internal combustion engine from the rest of the powertrain and to enable pure-electric driving via the electric machine.

Preferred embodiment forms of a hybrid module with disconnect clutch are characterized in that the disconnect clutch is constructed as a dog clutch. A more reliable connection or disconnection can be achieved in a simple manner by means of a dog clutch. A further advantage of a dog clutch consists in the simple construction and small installation space.

Embodiment forms of a hybrid module are characterized in that the actuating means of the disconnect clutch are arranged at the bearing plate. The actuating means of an optional disconnect clutch are advantageously mounted at the bearing plate which facilitates supply to and fastening of the actuating means.

A preferred dog clutch substantially comprises a sliding sleeve which produces the transfer of torque between the input shaft and the starter element via an inner toothing and an outer toothing.

The actuating means are carried out, for example, via a ferromagnetic tie rod which is fixedly axially connected to the sliding sleeve but can rotate relative to the sliding sleeve and an electromagnetic coil which can pull the tie rod in direction of the bearing plate.

Alternatively, the actuating means can also be carried out via a hydraulically actuated piston, particularly an annular piston.

One aspect of the invention is a hybrid module for arranging between an internal combustion engine, an electric machine and a transmission. The hybrid module has an input shaft which is connectible to a torsional damper mounted at the internal combustion engine. A starting element is provided. The input shaft is connected to the input side of the starting element. A transmission shaft is connectible to the output side of the starting element. The electric machine is arranged axially parallel to the input shaft and output shaft. The electric machine is connected to the output side of the starting element by a traction mechanism drive. The invention is characterized in that a bearing plate is provided which is arranged directly adjacent the torsional damper, in that a housing of the starting element has an axial portion which coaxially circumscribes the input shaft, and in that a plurality of coaxial seals is arranged in the region of the bearing plate in order to form a multi-stage sealing system.

A plurality of coaxially arranged seals is preferably to be provided in order to seal various oil spaces relative to one another.

The housing of the starting element advantageously has an axial portion which extends coaxial to the input shaft and which is usable for guiding and receiving seals and/or for bearing support.

Embodiment forms of a hybrid module are characterized in that a bearing is provided between the bearing plate and the axial portion of the housing of the starting element, which bearing supports the axial portion in radial direction, preferably in radial and axial direction. A stable support is achieved in a simple manner by means of a bearing support of the starting element directly at the bearing plate. Preferably, in addition to a radial bearing support via the bearing, a bearing support is also carried out in axial direction. A bearing support in axial direction has the advantage that a possible inflation of the starting element during operation takes place chiefly on the transmission side so that an axial displacement of the traction mechanism drive which is mounted at the housing on the drive side is prevented as far as possible or minimized. In this way, a negative influence of the traction mechanism drive can be reduced. Alternatively, in case of a transmission-side connection of the traction mechanism drive, the axial support can correspondingly be carried out advantageously on the transmission side and the bearing can be constructed so as to support only radially at the bearing plate.

Embodiment forms of a hybrid module are characterized in that the starting element is formed as a hydrodynamically cooled clutch. A hydrodynamically cooled clutch is a multiple-disk clutch in a completely filled oil space in which an internal flow of cooling oil is generated inside of the starting element particularly via the disk shape and/or grooves in the friction faces. An advantage of the hydrodynamically cooled clutch resides in a flexible usability, for one, as a conventional launch element in a conventional drive and also as a disconnect clutch for pure-electric driving and as start-up clutch for starting (cranking) the internal combustion engine during driving. In this way, further corresponding component parts and the manufacturing and assembly costs associated with them can be dispensed with and installation space can be saved.

Embodiment forms of a hybrid module with a hydrodynamically cooled clutch are characterized in that the input shaft is connected to an inner plate carrier, in that the output shaft is connected to the housing of the starting element which comprises an outer plate carrier such that the output shaft is fixed with respect to rotation relative to the housing. Accordingly, the inner plate carrier is the input side of the starting element and the traction mechanism drive can simply be connected to the housing as output side.

Hybrid modules according to embodiment forms are characterized in that the sealing system has a first seal between the input shaft and the axial portion in order to form a pressureless intermediate space opposite a filled wet space in the housing of the starting element, in that the sealing system has a second seal between the bearing plate and the input shaft in order to seal the intermediate space relative to a dry space, and in that a third seal is provided between the bearing plate and the axial portion in order to seal the intermediate space relative to a further wet space in which the traction mechanism drive is arranged.

In order to ensure a filling of the wet space in the housing of the starting element, this wet space has a higher pressure than the surrounding space. Since a relative movement may occur between the input shaft and the housing of the starting element, or the axial portion of the housing, direct sealing is difficult. Therefore, a first seal is provided by means of which a pressureless intermediate space is formed in which there is no longer a higher pressure but oil can also still leak from the starting element.

A second seal which is arranged between, preferably, the bearing plate and the input shaft is provided so that the intermediate space is sealed relative to a drive-side dry space. This second seal can prevent possibly leaking oil from escaping from the intermediate space. A radial sealing ring can be used, for example, as second seal. A further wet space in which the traction mechanism drive is arranged is sealed relative to the intermediate space by means of a third seal between the bearing plate and an axial portion of the housing of the starting element.

Embodiment forms of a hybrid module are preferably characterized in that the third seal is constructed as a radial shaft seal which seals in both directions. In particular, when the further wet space and the wet space in the starting element are supplied via different oil circuits, a mixing of the oil circuits can be prevented by means of a third seal acting on both sides.

Hybrid modules according to embodiment forms are characterized in that the input shaft has at least one discharge opening in the region of the intermediate space in order to discharge a leakage oil radially inward, particularly via the transmission shaft, to a transmission sump. A buildup of pressure in the intermediate space is prevented in this way so that the functioning of the sealing system is improved.

An aspect of the invention is also a hybrid module for arranging between an internal combustion engine, an electric machine and a transmission, the hybrid module having an input shaft which is connectible to a torsional damper mounted at the internal combustion engine. A starting element is provided, and a transmission shaft is connectible to the output side of the starting element. The electric machine is arranged axially parallel to the input shaft, and the electric machine is connected to a traction mechanism drive with the starting element. The hybrid module is characterized in that a bearing plate is provided which is arranged directly adjacent the torsional damper, in that a disconnect clutch is provided between the input shaft and the starting element, and in that the disconnect clutch is constructed as a dog clutch.

Embodiment forms of a hybrid module are characterized in that the starting element is formed as a torque converter. By means of a torque converter, a hydrodynamic torque multiplication can be provided, which improves the launch performance of the starting element.

In addition, the torque converter preferably has a lockup clutch to allow a direct connection between input side and output side after start-up. Depending on the existing installation space, an optional further torsional damper can be additionally provided in the lockup clutch in order to further damp possible torsional vibrations of the internal combustion engine and increase driving comfort. Alternatively, the further torsional damper may be omitted in order to reduce installation space.

Embodiment forms of a hybrid module with a torque converter are characterized in that a seal is provided between the bearing plate and the input shaft in order to seal a further wet space from the dry space, and in that the wet space of the housing of the starting element is formed closed on the drive side. A seal is provided in order to seal the further wet space from the drive-side dry space, the traction mechanism drive being arranged in this wet space. With respect to its arrangement, this seal approximately corresponds to that of the second seal described above in a hydrodynamically cooled clutch. The sealing is carried out directly against the further wet space rather than against an intermediate space.

Particularly in the case of a torque converter, the housing is formed completely closed on the drive side and constitutes the input side of the starting element. Accordingly, sealing need only be carried out with regard to a through-passage of a transmission shaft or a co-rotationally fixed region for a stator of the torque converter.

Embodiment forms of a hybrid module are characterized in that a housing of the hybrid module is formed integral with a housing of the electric machine. The housing of the hybrid module may also receive the electric machine for purposes of an exact positioning relative to one another and to reduce individual parts. A further advantage consists in that the further wet space for the traction mechanism drive is located in a defined interior space.

Hybrid modules according to embodiment forms are characterized in that a housing of the hybrid module is constructed separate from a housing of the electric machine and these housings are connectible to one another. The size and complexity of the housings are reduced as a result of being formed separately and, further, different electric machines can be connected to the unitary hybrid module more easily, which allows different variants to be realized more simply.

Embodiment forms of a hybrid module with separate housings for the hybrid module and the electric machine are characterized in that the relative position of the housings of the hybrid module and electric machine is variable via adjusting means in order to tension the traction mechanism drive. Tensioning means typically provided for the traction mechanism drive may be dispensed with when the housings are constructed separately and are connectible via adjusting means. The relative position of the electric machine can be changed via the adjusting means so that the traction mechanism drive is tensionable. For example, by means of adjustable spacer sleeves or screws, the adjusting means can be formed with or without a connection of the housing that is articulated on one side or intermediate elements that may be introduced.

Embodiment forms of a hybrid module are characterized in that the housing of the hybrid module is formed separate from a housing of the transmission. In this way, the size of the component parts is kept smaller. A further advantage consists in that a hybrid module can be connected to different transmission variants.

Hybrid modules according to further embodiment forms are characterized in that the housing of the hybrid module is formed integral with a housing of the transmission. The number of component parts is reduced and assembly in the vehicle is facilitated by an integral construction of the housings.

A further aspect of the invention is a motor vehicle with a hybrid drive having a hybrid module according to one of the embodiment examples.

The features of the embodiment forms may be combined with one another in any desired manner.

### BRIEF DESCRIPTION OF THE DRAWINGS

The invention will be explained in more detail in the following with reference to the figures. Like or similar elements are designated with consistent reference numerals. In particular, the figures show:

FIG. 1 a schematic construction of an embodiment example;

FIG. 2 an embodiment example of a hybrid module;

FIG. 3 a further embodiment example of a hybrid module.

### DETAILED DESCRIPTION OF THE DISCLOSED EMBODIMENTS

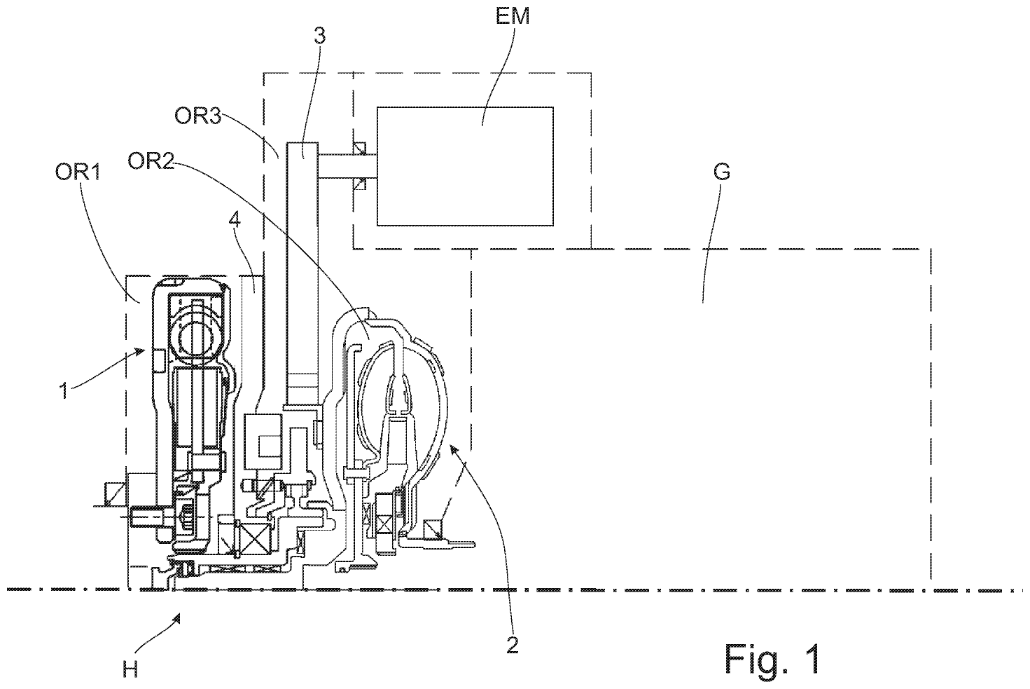

FIG. 1 shows a schematic construction of a portion of a powertrain with a hybrid module H according to the invention, only one half of which is shown in the further figures.

The hybrid module H is connected to an internal combustion engine, not shown, to be arranged on the left-hand side with reference to FIG. 1. The connection is carried out via a torsional damper 1 which is arranged in a dry space OR1. The dry space OR1 is separated from the interior of the hybrid module H via a bearing plate 4.

A starting element 2 containing a wet space OR2 is provided in the hybrid module H.

Further, the hybrid module H is connected to an electric machine EM via a traction mechanism drive 3. The electric machine EM is arranged axially parallel to the hybrid module H. The area in which the traction mechanism drive 3 is arranged constitutes a further wet space OR3.

The hybrid module H is further connected to a transmission G.

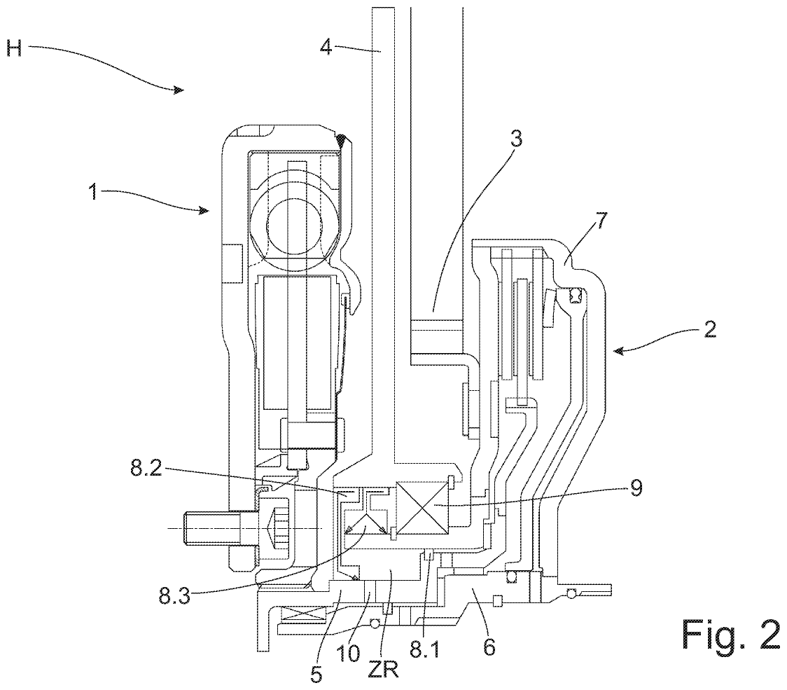

FIG. 2 shows a first embodiment example of a hybrid module H.

The torsional damper 1 connected to an internal combustion engine is connected via a spline to an input shaft 5 so as to be fixed with respect to rotation relative to it. The input shaft 5 is further connected to the input side of the starting element 2.

In this embodiment example, the starting element 2 is formed as a hydrodynamically cooled clutch. The input shaft 5 is connected to the inner plate carrier of the hydrodynamically cooled clutch which constitutes the input side of the starting element 2. The housing 7 of the starting element 2 which also constitutes the outer plate carrier in this case is connected to an output shaft 6 which is subsequently connected to, or is a part of, the transmission G, although this is not shown.

A part, in particular a sprocket, of a traction mechanism drive 3 is fixedly mounted at the housing 7 of the starting element 2. In principle, it is also possible that it is formed integral with the housing 7. The electric machine EM is directly connected to the output side of the starting element 2 via the traction mechanism drive 3.

The housing 7 also has an axial portion which extends coaxial to the input shaft 5 and which also partially overlaps the bearing plate 4 in axial direction. A bearing 9 which supports the starting element 2 in the hybrid module H is provided at the axial portion.

In addition to bearing 9, a third seal 8.3 is provided between the bearing plate 4 and the axial portion, which seal 8.3 seals the further wet space OR3 relative to an intermediate space ZR. In the depicted embodiment example, the third seal 8.3 is formed as a radial sealing ring operative at both sides. In the depicted example, the bearing 9 is arranged on the transmission side of the third seal 8.3. A reverse arrangement at the drive side in which the bearing 9 is arranged in the intermediate space is also possible.

A first seal 8.1 is provided between the input shaft 5 and the axial portion coaxially surrounding the input shaft 5. A wet space OR1 in the starting element 2 is sealed relative to the intermediate space ZR by means of the first seal 8.1.

Further, a second seal 8.2 is provided between the bearing plate 4 and the input shaft 5. The intermediate space ZR is sealed relative to the dry space OR1 by means of the second seal 8.2.

In the area of the intermediate space ZR or between the first seal 8.1 and the second seal 8.2, the input shaft 5 has at least one discharge opening 10 through which leakage oil located in the intermediate space ZR is discharged inward, preferably in direction of the transmission G.

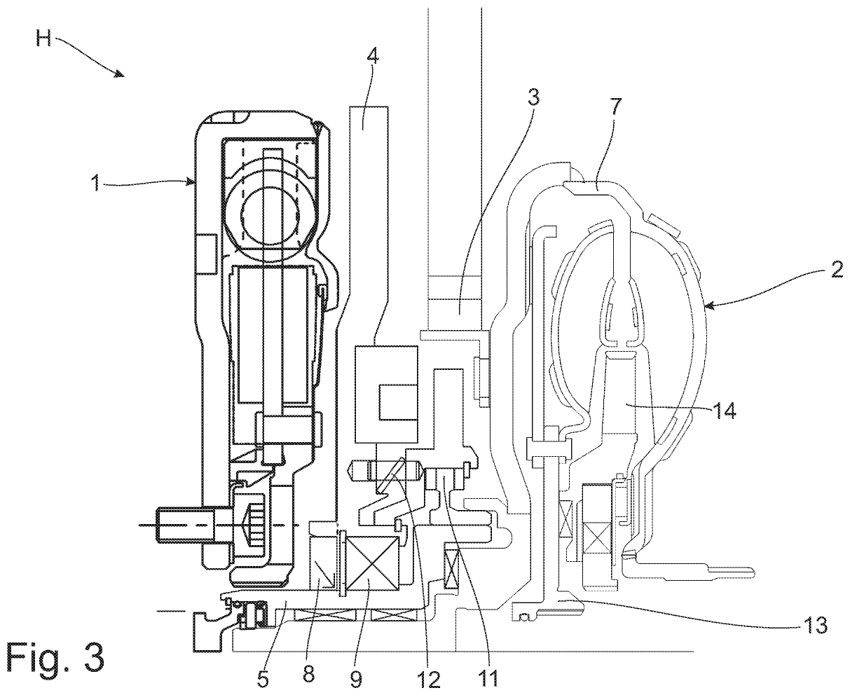

A further embodiment example of a hybrid module H whose basic arrangement corresponds to FIG. 2 is shown in FIG. 3.

The starting element 2 in FIG. 3 is formed as a torque converter. An impeller of the torque converter is fixedly connected to the housing 7 of the starting element 2 and constitutes the input side. A stator 14 is fixedly held via a transmission-side opening of the housing 7 by means of a connection, not shown, to a housing of the hybrid module H or of the transmission G. The turbine 13 is connectible, for example, via a spline, to an output shaft 6, not shown in FIG. 3, or a transmission shaft so as to be fixed with respect to rotation relative to it and constitutes the output side of the starting element 2.

Further, a lockup clutch is shown schematically at the turbine 13. A direct connection between the input side and output side can be produced by means of this lockup clutch.

The housing 7 of the starting element 2 is likewise connected to a traction mechanism drive 3 analogous to FIG. 2 which, in this embodiment example, produces a connection of the electric machine EM to the input side.

In this example, a disconnect clutch 11 is provided between the input shaft 5 and the driving element 2. The disconnect clutch 11 shown here is formed as a dog clutch and, via a sliding sleeve, produces a connection between an outer toothing provided on the input shaft 5 and an inner toothing provided at the housing 7 of the starting element 2. Alternatively, other constructions of a dog clutch, as well as other clutches, are also possible.

The actuating means 12 of the disconnect clutch 11 are mounted at the bearing plate 4 to axially displace the sliding sleeve.

Since the torque converter in the embodiment example shown in FIG. 3 has a completely closed housing 7 on the drive side, the seal system can be constructed in a simpler manner compared to FIG. 2. A seal 8 and a bearing 9 are provided between the bearing plate 4 and the input shaft 5.

Further, the invention is also not limited to the embodiments described above. As has already been mentioned, advantageous features can also be provided in isolation or combined with one another.

1. A Hybrid module for arranging between an internal combustion engine, and an electric machine and a transmission, wherein the hybrid module has an input shaft which is connectible to a torsional damper mounted at the internal combustion engine, wherein a starting element is provided, wherein a transmission shaft is connectible to the output side of the starting element, wherein the electric machine is arranged axially parallel to the input shaft, wherein the electric machine is connected to the starting element by a traction mechanism drive, and wherein a bearing plate is provided which is arranged directly adjacent the torsional damper, in that a disconnect clutch is provided between the input shaft and the starting element, and in that the disconnect clutch is constructed as dog clutch.

2. The Hybrid module according to claim 1, wherein the traction mechanism drive is connected to the housing of the starting element.

3. The Hybrid module according to claim 1, wherein the starting element is formed as torque converter.

4. The Hybrid module according to claim 1, wherein the housing of the starting element is formed on the drive side as a closed wet space.

5. The Hybrid module according to claim 1, wherein a seal is provided between the bearing plate and the input shaft in order to seal a further wet space from the dry space.

6. The Hybrid module according to claim 1, wherein a bearing is provided between the bearing plate and the input shaft in order to support the input shaft at least in a radial direction.

7. The Hybrid module according to claim 1, wherein the actuating means of the disconnect clutch are arranged at the bearing plate.

8. The Hybrid module according to claim 1, wherein a housing of the hybrid module is formed integral with a housing of the electric machine.

9. The Hybrid module according to claim 1, wherein a housing of the hybrid module is constructed separate from a housing of the electric machine, and these housings are connectable to one another.

10. The Hybrid module according to claim 9, wherein the relative position of the housings of the hybrid module and of the electric machine is variable via adjusting means in order to tension the traction mechanism drive.

11. The Hybrid module according to claim 1, wherein the housing of the hybrid module is formed separate from a housing of the transmission.

12. The Hybrid module according to claim 1, wherein the housing of the hybrid module is formed integral with a housing of the transmission.

13. A Motor vehicle with a hybrid drive having a hybrid module according to claim 1.

14. The Hybrid module according to claim 6, wherein the input shaft is supported in the radial and axial directions.
